(19) United States
(12) Patent Application Publication
(10) Pub. No.: US 2007/0202795 A1
(43) Pub. Date: Aug. 30, 2007

(54) Induced flow fan with outlet flow measurement

(75) Inventors: Michael G. Seliger, Marathon, WI (US); Scott S. Kurszewski, Wittenberg, WI (US)

Correspondence Address: QUARLES & BRADY LLP, 411 E. WISCONSIN AVENUE, SUITE 2040, MILWAUKEE, WI, 53202-4497, US

(73) Assignee: Greenheck Fan Corporation

(21) Appl. No.: 11/362,323

(22) Filed: Feb. 24, 2006

(51) Int. Cl. B60H 1/34

(52) U.S. Cl. 454/155

(57) ABSTRACT

An induced flow fan assembly is provided with a pressure tap arrangement at the outlet for measuring the output flow of the assembly. The pressure sensing arrangement includes two rings of piezometers mounted to an outlet windband, one ring at the wider upstream end of the wind band and the outer at the narrower downstream end. Data regarding the pressure differential across the windband is acquired electronically and used to determine total output flow of inlet and entrained air streams. The fan assembly is suitable as an exhaust assembly for expelling contaminated air from a building.

### CROSS-REFERENCE TO RELATED APPLICATIONS

Not applicable.

### STATEMENT OF FEDERALLY SPONSORED RESEARCH/DEVELOPMENT

Not applicable.

### BACKGROUND OF THE INVENTION

The present invention relates generally to induced flow fans of the type having greater outlet flow than inlet flow, and more particularly to the measurement of outlet flow of such fans.

One example of an application where induced flow fans are commonly used is in building exhaust systems for buildings such as laboratories that produce fumes from chemical and biological processes that may be malodorous, noxious or toxic. The exhaust systems draw contaminated air from the building, mix the contaminated air with ambient air to dilute the contaminants, and vent the diluted air from the building into the ambient environment. Exhaust systems have been devised to expel the mixed air in a plume at a high velocity high above the building so that ground air is not affected by the exhaust. Examples of such systems are described in U.S. Pat. Appl. Pub. Nos. 2005/0170767 and 2005/0159102, assigned to the assignee of the present invention and the entire disclosures of which are hereby incorporated by reference as though fully set forth herein.

To ensure that the plume of diluted contaminated air is expelled sufficiently high in the air, it is important to monitor system performance with the fan operating in the field as intended. Of particular importance to proper performance is the volumetric flow rate of the expelled air, typically measured in cubic feet per minute (CFM). One conventional technique for calculating the flow rate of the expelled air is to place an anemometer (or similar flow measuring device) in path of the expelled air to develop a velocity profile across the outlet. The flow rate can be calculated as a product of the average velocity and the sectional area of the outlet. This technique is generally inaccurate due to the complicated velocity profiles that are characteristic of induced flow fans, and because the physical presence of the measuring device will interfere with the flow of the expelled air being measured. This technique may also subject a human technician to the potentially harmful fumes and contaminants in the expelled air.

Fan manufacturers, such as Greenheck Fan Corporation, may have in-house test laboratories with room-sized air chambers for accurately measuring outlet flow of the large induce flow fans used in building exhaust systems. The large, complex test facilities required to measure outlet flow by the fan manufacturer cannot be used to measure system performance once an exhaust system is installed in a building.

What is therefore desired is a system for accurately measuring the outlet flow of an induced flow fan such as that used in building exhaust applications without interfering with the efficient operation of the exhaust system in the field or requiring human exposure to exhaust contaminants.

### BRIEF SUMMARY OF THE INVENTION

The present invention provides an induced flow fan assembly with an air measurement system at the outlet for measuring the output flow of the assembly. The measurement system is a pressure sensing arrangement located at the fan outlet so as not to significantly disturb the outlet flow and allow accurate measurement and monitoring of output flow. The flow data can be acquired and analyzed without human interface with the outlet flow. The fan assembly can be used as part of an exhaust assembly for expelling contaminated air from a building.

In accordance with one aspect of the present invention, an induced flow fan assembly includes a housing defining an interior flow path in communication with an air inlet, an air entrainment opening and an air outlet. A fan is disposed in the housing interior to draw air in through the air inlet and the air entrainment opening and to blow the air through the flow path and out the outlet. Air from the entrainment opening(s) is combined with air from the air inlet so that flow through the air outlet is greater than flow through the air inlet. A pressure sensing arrangement located at the air outlet is used to measure air flow output from the fan assembly.

The air outlet can be formed by a windband mounted over an outlet end of the housing, such as an upper end opposite the air inlet. The windband can be any conventional shape, such as a cone necking inwardly from an upstream end to a downstream end. Regardless of the particular configuration, the upstream end defines an opening of greater sectional area than an opening at the downstream end. Moreover, the opening at the upstream end of the windband has a greater sectional area than an opening at the outlet end of the housing so as to form the air entrainment opening there between.

The pressure sensing arrangement can include one or more pressure taps located at the upstream end of the windband and another one or more pressure taps located at the downstream end of the windband, thereby at different axial locations (or heights) so that a pressure drop across the windband can be detected and used to determine the output air flow.

Multiple pressure taps can form one or more piezometer rings, preferably one ring being mounted at the interior of each end of the windband. The taps at each end can be spaced apart angularly to form the rings, for example three or more pressure taps can be used, and more particularly four pressure taps can be located at the 3, 6, 9 and 12 o'clock positions. The use of multiple taps at each axial position prevents the measurement system from being rendered inoperable from a blocked or damaged tap, and corrects for uneven pressure differential at different locations angular positions around the windband.

A computer or other control module can be electrically coupled to the transducer arrangement, thereby providing for electronic system monitoring and analysis of the pressure data for determining output air flow based on readings from the taps.

In accordance with another aspect, the present invention provides an exhaust assembly for expelling exhaust air from a building. In one form the exhaust assembly includes a housing having an air inlet receiving the exhaust air, at least one ambient air entrainment zone mixing ambient air with the exhaust air to produce combined air, and an air outlet exhausting the combined air. A fan is disposed in the housing interior for drawing exhaust air in through the air inlet and ambient air into the entrainment zone and blowing the combined air through the air outlet. A pressure sensing assembly located at the air outlet is used to acquire pressure data indicative of air flow output from the exhaust assembly. The assembly has one or more pressure taps at one axial position of the air outlet and one or more pressure taps at another axial position of the air outlet. In another form, the exhaust assembly includes a housing defining an air inlet receiving the exhaust air, a windband defining an air outlet and being mounted to an upper end of the housing opposite the air inlet, and at least one ambient air entrainment zone mixing ambient air with the exhaust air to produce combined air. The wind band has an upstream end defining an opening of greater sectional area than that of an opening defined by a downstream end.

In the following description, reference is made to the accompanying drawings, which form a part hereof, and in which there is shown by way of illustration, and not limitation, a preferred embodiment of the invention. Such embodiment also does not define the scope of the invention and reference must therefore be made to the claims for this purpose.

### BRIEF DESCRIPTION OF THE DRAWINGS

Reference is hereby made to the following drawings in which like reference numerals correspond to like elements throughout, and in which:

FIG. 1 is a schematic perspective view of a building ventilation system constructed in accordance with principles of the present invention;

FIG. 2 is a side elevation view of an exhaust assembly constructed in accordance with the preferred embodiment;

FIG. 3 is a sectional side elevation view showing the fan assembly of the exhaust assembly illustrated in FIG. 2;

FIG. 4 is a sectional view taken in the plane 4-4 shown in FIG. 3;

FIG. 5 is a sectional view taken in the plane 5-5 shown in FIG. 3;

FIG. 6 is a schematic diagram of the outlet windband and transducer assembly; and

FIG. 7 shows a sample calibration curve for correlating pressure change data to outlet flow.

### DETAILED DESCRIPTION OF THE PREFERRED EMBODIMENT

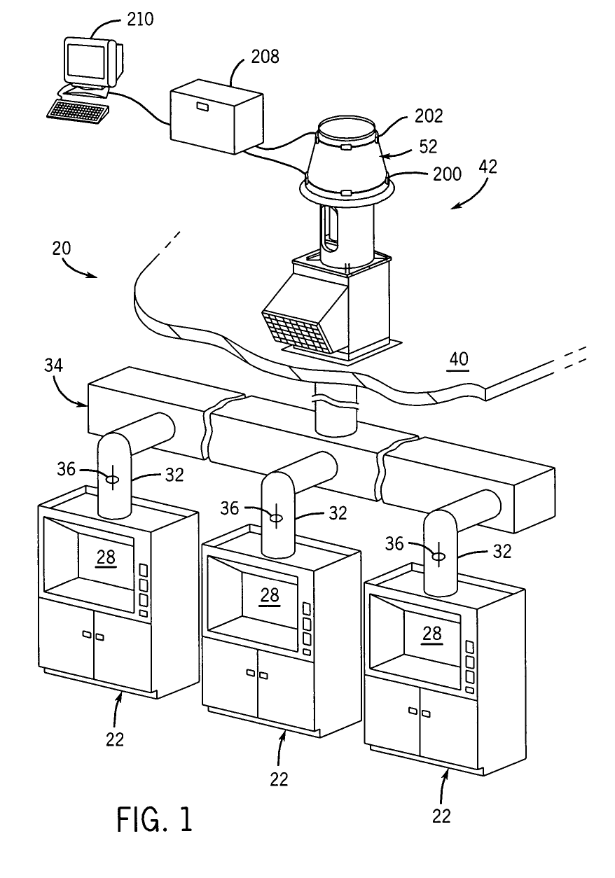

Referring to FIG. 1, a building ventilation system 20 includes one or more fume hoods 22 of the type commonly installed in commercial kitchens, laboratories, manufacturing facilities, or other appropriate locations throughout a building that create noxious or other gasses that are to be vented from the building. In particular, each fume hood 22 defines a chamber 28 that is open at a front of the hood for receiving surrounding air. The upper end of chamber 28 is linked to the lower end of a conduit 32 that extends upwardly from the hood 22 to a manifold 34. Manifold 34 is further connected to a riser 38 that extends upward to a roof 40 or other upper surface of the building. The upper end of riser 38 is, in turn, connected to an exhaust fan assembly 42 that is mounted on top of roof 40 and extends upwardly away from the roof for venting gasses from the building. The components of exhaust fan assembly 42 are made of a metal, and preferably steel, unless described otherwise herein.

The building can be equipped with more than one exhaust assembly 42, each such assembly 42 being operably coupled either to a separate group of fume hoods 22 or to manifold 34. Accordingly, each exhaust assembly 42 can be responsible for venting noxious gasses from a particular zone within the building 26, or a plurality of exhaust assemblies 42 can operate in tandem off the same manifold 34. In addition, the manifold 34 may be coupled to a general room exhaust in building 26. An electronic control system 210 may be used to automatically control the operation of the system. The control of this system typically includes both mechanical and electronic control elements. A conventional damper 36 is disposed in conduit 32 at a location slightly above each hood 22, and is automatically actuated between a fully open orientation (as illustrated) and a fully closed orientation to control exhaust flow through the chamber 28. Hence, the volume of air that is vented through each hood 22 is controlled.

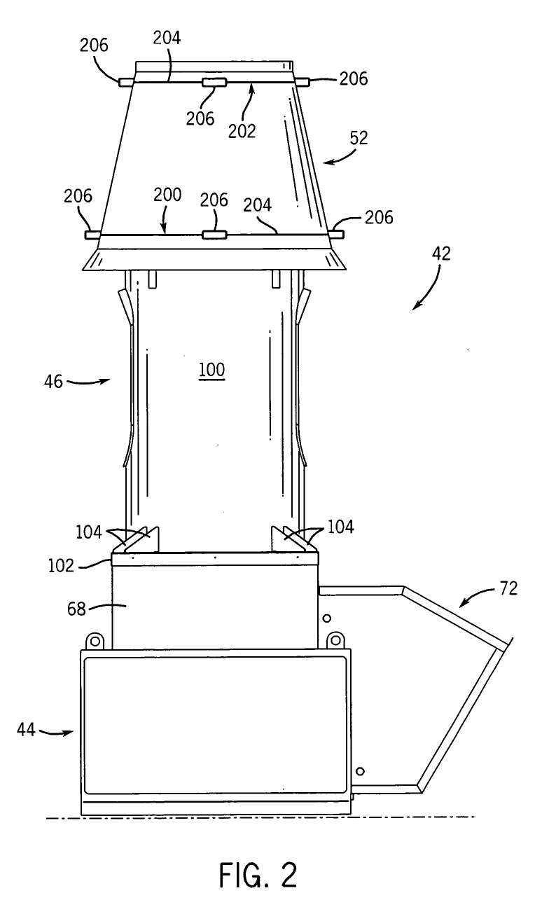

More specifically now, with reference to FIG. 2, the exhaust assembly 42 includes a plenum 44 disposed at the base of the assembly that receives exhaust from riser 38 and mixes it with fresh air. A fan assembly 46 is connected to, and extends upwards from, plenum 44. Fan assembly 46 includes a fan wheel that draws exhaust upward through the plenum 44 and blows it out through a windband 52 disposed at its upper end. During operation, exhaust assembly 42 draws an airflow that travels from each connected fume hood 22, through chamber 28, conduits 32, manifold 34, riser 38 and plenum 44. This exhaust air is mixed with fresh air before being expelled upward at high velocity through an opening in the top of the windband 52.

A rectangular pedestal 68 is fastened to the top wall of the plenum 44 that serves as the support for the fan assembly 46. A hood 72 extends outwardly from the housing to provide a bypass air inlet to the plenum 44. An electronically or pneumatically controlled damper is mounted beneath the hood 72 to control the amount of ambient air that enters the plenum housing through the bypass air inlet to enable a flow of bypass air into the plenum 44 which maintains a constant total air flow into the fan assembly 46 despite changes in the volume of air exhausted from the building. Exhaust air from the building enters the plenum 44 through an exhaust inlet formed in the bottom of the rectangular housing and mixes with the bypass air to produce once-diluted exhaust air that is drawn upward through an exhaust outlet in the top of the pedestal 68 and into the fan assembly 46.

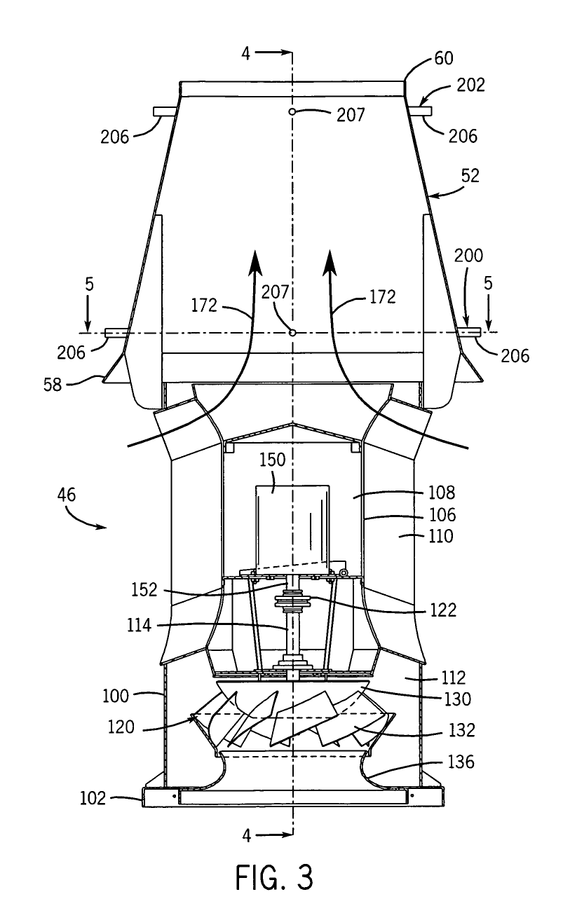

Referring to FIGS. 2 and 3, the fan assembly 46 sits on top of the plenum 44 and has a housing with a cylindrical outer wall 100 that is welded to a rectangular base plate 102. A set of eight gussets 104 is welded around the lower end of the outer wall 100 to help support it in an upright position. Supported inside the outer wall 100 is a cylindrical shaped inner wall 106 which divides the interior of the housing into three parts: a central drive chamber 108, a surrounding annular space 110 located between the inner and outer walls 106 and 100, and a fan chamber 112 located beneath drive chamber 108. The fan chamber 112 and annular space 110 form part of the building exhaust air flow path, while drive chamber 108 is isolated from the flow path and thus is not exposed to contaminants associated with the exhaust air.

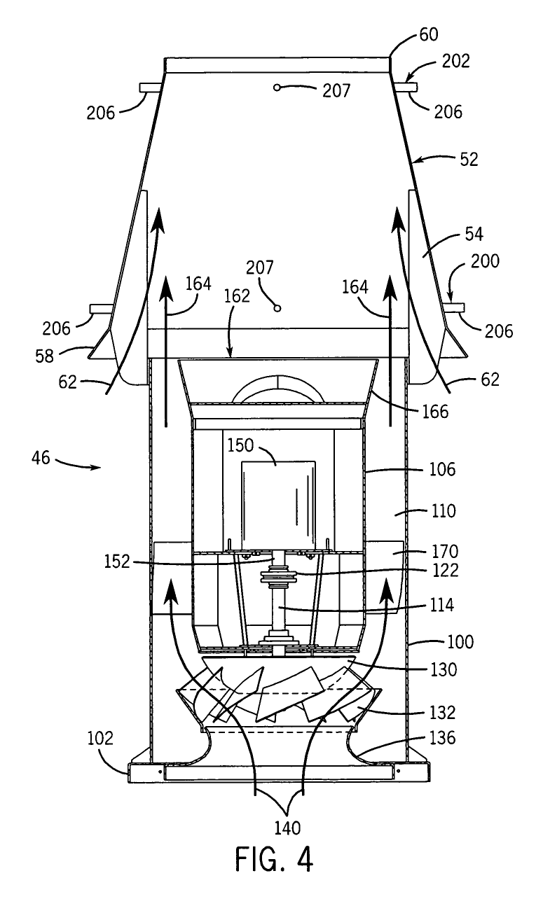

A fan shaft 114 is disposed in drive chamber 108 and extends down into the fan chamber 112 to support a fan wheel 120 at its lower end, and extends up into drive chamber 108 where it is connected to a motor shaft 152 of a fan drive motor 150 via a compliant flexible coupling 122 that compensates shaft misalignments in at least one, and more preferably two, orientations (e.g., angular and axial shaft misalignments). The fan wheel 120 includes a dish-shaped wheelback 130 having a set of main fan blades 132 fastened to its lower surface that support a frustum-shaped rim extending around the perimeter of the fan blades. The lower edge of this rim fits around a circular-shaped upper lip of an inlet cone 136 that fastens to, and extends upward from the base plate 102. The fan wheel 120 is a mixed flow fan wheel such as that sold commercially by Greenheck Fan Corporation under the trademark MODEL QEI and described in pending U.S. patent application Ser. No. 10/297,450 which is incorporated herein by reference. When the fan wheel 120 is rotated, exhaust air from the plenum 44 is drawn upward through the air inlet formed by the inlet cone 136 and blown radially outward and upward into the annular space 110 as shown by arrows 140 in FIG. 4.

Referring now also to FIG. 4, the exhaust air moves up through the annular space 110 and exits through an annular-shaped nozzle 162 formed at the upper ends of walls 100 and 106 as indicated by arrows 164. The nozzle 162 is formed by flaring the upper end 166 of inner wall 106 such that the cross-sectional area of the nozzle 162 is substantially less than the cross-sectional area of the annular space 110. As a result, exhaust gas velocity is significantly increased as it exits through the nozzle 162. Vanes 170 are mounted in the annular space 110 around its circumference to straighten the path of the exhaust air as it leaves the fan and travels upward. The action of vanes 170 has been found to increase the entrainment of ambient air into the exhaust as will be described further below.

The windband 52 is mounted on the top of fan assembly 46 and around nozzle 162. A set of brackets 54 is attached around the perimeter of the outer wall 100. Brackets 54 extend upward and radially outward from the top rim of outer wall 100, and fasten to the windband 52. Windband 52 is essentially frustum-shaped with a large circular bottom opening coaxially aligned with the annular nozzle 162 about a central axis 56. The bottom end of the windband 52 is flared by an inlet bell 58 and the bottom rim of the inlet bell 58 is aligned substantially coplanar with the rim of the nozzle 162. The top end of the windband 52 is terminated by a circular cylindrical ring section 60 that defines the exhaust outlet of the exhaust assembly 42.

The windband 52 is dimensioned and positioned relative to the nozzle 162 to entrain a maximum amount of ambient air into the exhaust air exiting the nozzle 162. The ambient air enters through an annular gap formed between the nozzle 162 and the inlet bell 58 as indicated by arrows 62. It mixes with the swirling, high velocity exhaust exiting through nozzle 162, and the mixture is expelled through the exhaust outlet at the top of the windband 52.

Ambient air is also drawn in through the passageways and mixed with the exhaust air as indicated by arrows 172. This ambient air flows out the open top of the flared inner wall 106 and mixes with the exhaust emanating from the surrounding nozzle 162. The ambient air is thus mixed from the inside of the exhaust. Thus, the outlet flow expelled from the exhaust assembly 42 is a combination of the exhaust air coming from the plenum 44 and passing through the inlet cone 136 and the entrained ambient air passing through passages 62 in the path of arrows 172.

It is important to evaluate and monitor the performance of the system to ensure that the diluted contaminated air stream is expelled high enough from the building so as not to affect surface air quality. In induced flow fan systems, such as the exhaust assembly 42 described above, it is not possible to accurately assess output flow characters by evaluating the inlet side of the system because the outlet flow differs dramatically from the inlet flow due to the entrained ambient air. Acquiring data from the outlet side is difficult to do without affecting outlet air flow, which could decrease system efficiency and performance and thereby render the output flow measurement inaccurate. Thus, conventional air flow measurement devices, such as anemometers and the like are not suitable for this purpose. Nor are any devices that require human exposure to the exhausted air stream because of the potentially harmful contaminants therein. Further, assessing flow at the outlet side by analyzing air velocity is made even more difficult because the entrained ambient air streams can render the velocity profile at the outlet virtually undeterminable.

The inventors of the present invention have concluded that it is possible to accurately assess flow output of the exhaust system 42 by evaluating the pressure drop across the outlet, particularly the pressure drop from the upstream (or inlet bell 58) side of the windband 52 to the downstream side of the windband 52 at the cylindrical ring 60. The inlet bell 58 of the windband 52 defines a circular opening of a particular sectional area (in the plane perpendicular to the vertical central axis 56 of the assembly) and the ring 60 defines another sectional area that is less than that of the inlet bell 58. The frustum wall of the windband 52 tapers radially inward from the inlet bell 58 to the ring 60. As such, the windband 52 effectively forms a venturi tube. Under conditions of steady, incompressible flow, a combination of the continuity equation regarding the conservation of mass (ρ₁V₁A₁=ρ₂V₂A₂) and the Bernoulli equation (P₁+½ρ₁V₁²+ρ₁g₁h₁=P₂+½ρ₂V₂²+ρ₂g₂h₂) can be used to calculate the output flow velocity.

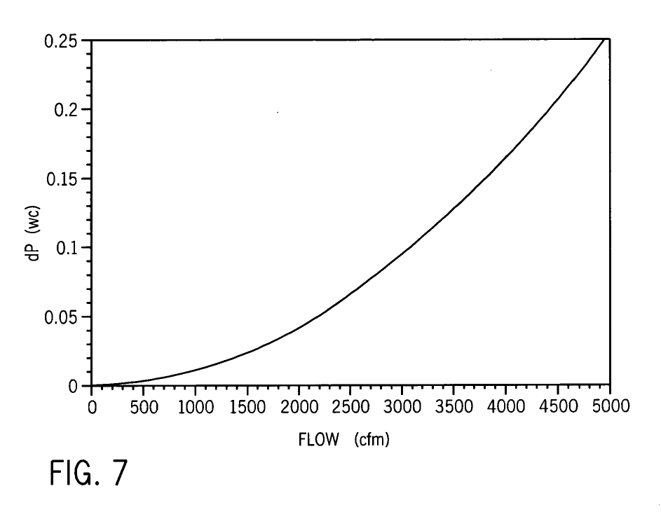

However, in light of the uneven velocity profile at the outlet of the exhaust system arising from the induced flow, it is necessary to test each exhaust assembly configuration and determine the correlation between the pressure drop across the outlet windband 52 and the output flow empirically. Using the empirical data, flow equations can be devised for each exhaust assembly configuration or fan size. The flow equations are non-linear, square root expressions having a constant dependent on the fan size. The flow equations thus take the form: output flow (cfm)=C×\sqrt{dP /_{ρ},}wherein C is the empirically determined constant specific to the exhaust assembly configuration and/or fan size, dP is the static pressure differential at the windband, and ρ is the standard density (0.075 lb/ft³). From the flow equation, a calibration curve, such as that shown in FIG. 7 can be generated for each exhaust assembly configuration/fan size. Using either the equation or the calibration curve, pressure data acquired at the windband can be correlated to output flow.

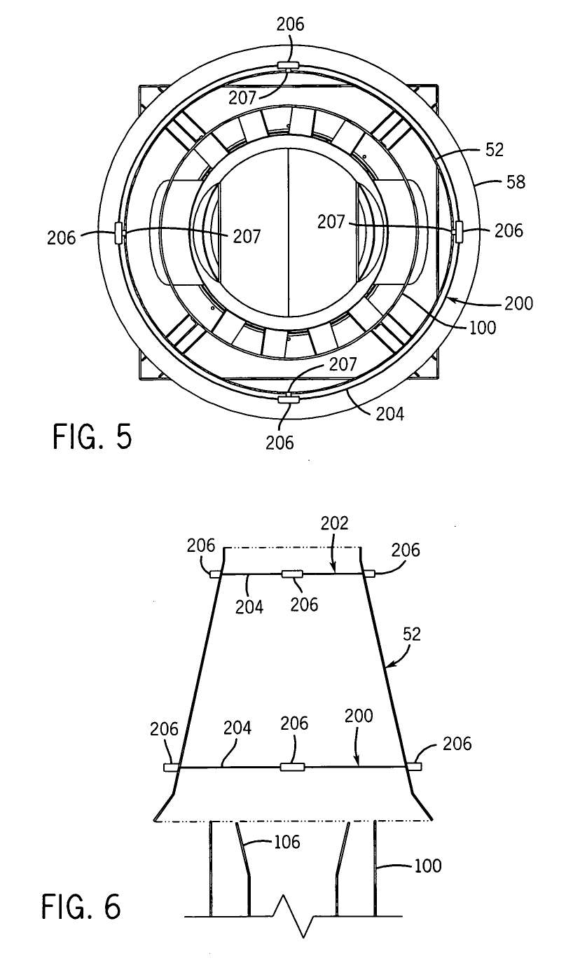

As shown in FIGS. 4-6, to obtain the pressure differential data at the outlet without interfering with output flow, a low profile pressure sensing arrangement is mounted to the windband. In particular, two piezometer rings 200 and 202 are mounted at to the windband 52, one at the inlet bell 58 and one at the cylindrical ring 60. Each ring extends about the exterior of the windband and is formed of plastic or metal tubing 204 connecting a plurality of T-shaped pressure taps 206. The taps are mounted in any suitable manner, such as by welding, over small diameter openings 207 extending to the interior side of the windband 52. The taps do not extend into the inside of the windband so as not to affect outlet flow distribution and velocity. Each ring 200 and 202 includes a plurality of pressure taps spaced apart angularly about the ring, for example four taps located at the 3, 6, 9 and 12 o'clock positions. The use of multiple pressure taps serves two purposes. First, should one tap fail, for example, if damaged or blocked from use, the system could operate based on reading from one or more of the other taps. Second, pressure data can be acquired at multiple angular positions at the two axial positions of the windband 52, thereby allowing the data to be averaged or a spurious reading (perhaps form a damaged or blocked tap) to be detected. Thus, the use of multiple taps at both ends of the windband 52 increases the life and accuracy of the system.

The piezometer rings 200 and 202 are both connected via separate tubing to a differential pressure transmitter 208 having a pressure cell, such as Model 677 commercially available from Dwyer Instruments, Inc., which is mounted nearby or remote to the exhaust assembly 42, preferably at a height above the rings 200 and 202 so as to prevent condensation from building up in the pressure cell. The pressure transmitter 208 is in turn coupled to a dedicated or main system controller or computer 210 for automatic electronic data acquisition and analysis and system monitoring. In response to the pressure data, system parameters, such as fan speed, can be controlled to increase system efficiency and/or alter outlet flow conditions. This can be done with human intervention, or automatically using appropriate control hardware. Flow output values can be computed using software algorithms based on the flow equation for the particular exhaust assembly configuration or fan size. Pressure differential or outlet flow values could also be recorded and/or output to a graphical user interface for evaluation by a technician.

The above description has been that of the preferred embodiment of the present invention, and it will occur to those having ordinary skill in the art that many modifications may be made without departing from the spirit and scope of the invention. In order to apprise the public of the various embodiments that may fall in the scope of the present invention, the following claims are made.

1. An induced flow fan assembly comprising:
a housing defining an interior flow path in communication with an air inlet, an air entrainment opening and an air outlet;
a fan disposed in the housing interior for drawing air in through the air inlet and the air entrainment opening and blowing the air through the flow path and out the outlet, air from the entrainment opening combining with air from the air inlet so that flow through the air outlet is greater than flow through the air inlet; and
a pressure sensing arrangement located at the air outlet for measuring air flow output from the fan assembly.

2. The induced flow fan assembly of claim 1, wherein the pressure sensing arrangement includes a first pressure tap at a first axial position of the air outlet and a second pressure tap at a second axial position of the air outlet different from the first axial position.

3. The induced flow fan assembly of claim 2, wherein there are a plurality of first pressure taps at the first axial position and a plurality of second pressure taps at the second axial position.

4. The induced flow fan assembly of claim 3, wherein the first pressure taps are located spaced angularly about the air outlet at the first axial position and the second pressure taps are spaced angularly about the air outlet at the second axial position.

5. The induced flow fan assembly of claim 4, wherein there are at least three first pressure taps angularly spaced apart and at least three second pressure taps angularly spaced apart.

6. The induced flow fan assembly of claim 3, wherein the plurality of first pressure taps form a first piezometer ring at the first axial position and the plurality of second pressure taps form a second piezometer ring at the second axial position.

7. The induced flow fan assembly of claim 1, wherein the air outlet is formed by a windband mounted over an outlet end of the housing.

8. The induced flow fan assembly of claim 7, wherein the windband has an upstream end and a downstream end, the upstream end defining an opening of greater sectional area than an opening at the downstream end.

9. The induced flow fan assembly of claim 8, wherein the opening at the upstream end of the windband has a greater sectional area than an opening at the outlet end of the housing so as to form the air entrainment opening there between.

10. The induced flow fan assembly of claim 8, wherein the pressure sensing arrangement includes a first pressure tap located at the upstream end of the windband and a second pressure tap located at the downstream end of the windband.

11. The induced flow fan assembly of claim 10, wherein there are a plurality of first pressure taps located at the upstream end of the windband and a plurality of second pressure taps located at the downstream end of the windband.

12. The induced flow fan assembly of claim 11, wherein the windband is a cone necking inwardly from the upstream end to the downstream end.

13. The induced flow fan assembly of claim 1, further including an electronic control coupled to the pressure sensing arrangement for calculating output air flow based on readings from one or more pressure taps of the pressure sensing arrangement.

14. The induced flow fan assembly of claim 1, wherein the housing includes:
an outer wall that defines a cavity therein having the air inlet at its bottom end; and
an inner wall fastened to the outer wall and positioned in the cavity to divide it into a central chamber which houses the fan and a surrounding annular space that receives air from the air inlet.

15. An exhaust assembly for expelling exhaust air from a building, the exhaust assembly comprising:
a housing having an air inlet receiving the exhaust air, at least one ambient air entrainment zone mixing ambient air with the exhaust air to produce combined air, and an air outlet exhausting the combined air;
a fan disposed in the housing interior for drawing exhaust air in through the air inlet and ambient air into the entrainment zone and blowing the combined air through the air outlet; and
a pressure sensing assembly located at the air outlet for measuring air flow output from the exhaust assembly, the pressure sensing assembly having a first pressure tap at a first axial position of the air outlet and a second pressure tap at a second axial position of the air outlet different from the first axial position.

16. The exhaust assembly of claim 15, wherein the air outlet is formed by a windband mounted over an upper end of the housing.

17. The exhaust assembly of claim 16, wherein the windband has an upstream end and a downstream end, the upstream end defining an opening of greater sectional area than an opening at the downstream end.

18. The exhaust assembly of claim 17, wherein there are a plurality of the first pressure taps at the upstream end of the windband and a plurality of the second pressure taps at the downstream end of the windband.

19. An exhaust assembly for expelling exhaust air from a building, the exhaust assembly comprising:
a housing defining an air inlet receiving the exhaust air;
a windband defining an air outlet, the windband being mounted to an upper end of the housing opposite the air inlet and having an upstream end and a downstream end, the upstream end defining an opening of greater sectional area than that of an opening defined by the downstream end;
at least one ambient air entrainment zone mixing ambient air with the exhaust air to produce combined air;
a fan disposed in the housing interior for drawing exhaust air in through the air inlet and ambient air into the entrainment zone and blowing the combined air through the windband air outlet; and
a pressure sensing assembly for measuring air flow expelled from the windband, the pressure sensing assembly having a first pressure tap at the upstream end of the windband and a second pressure tap at a downstream end of the windband.

20. The exhaust assembly of claim 19, wherein there are a plurality of the first pressure taps spaced apart in a ring at the upstream end of the windband and a plurality of the second pressure taps spaced apart in a ring at the downstream end of the windband.
